(19) United States
(12) Patent Application Publication
(10) Pub. No.: US 2012/0318990 A1
(43) Pub. Date: Dec. 20, 2012

(54) RADIATION DETECTION PANEL AND RADIATION IMAGING APPARATUS

(75) Inventors: Osamu Tsujii, Kawasaki-shi (JP); Masato Inoue, Kumagaya-shi (JP); Takashi Ogura, Tokyo (JP); Noriaki Oguri, Zama-shi (JP)

(73) Assignee: CANON KABUSHIKI KAISHA, Tokyo (JP)

(21) Appl. No.: 13/477,439

(22) Filed: May 22, 2012

(30) Foreign Application Priority Data
Jun. 14, 2011 (JP) 2011-132708

(51) Int. Cl. G01T 1/20

(52) U.S. Cl. 250/366; 250/361 R; 250/368

(57) ABSTRACT

A radiation detection panel including a photoelectric conversion element that detects fluorescence by a phosphor layer, the radiation detection panel comprising: a base material for supporting the phosphor layer, including the photoelectric conversion element; and a protective film for covering the phosphor layer, wherein the phosphor layer is formed on a surface and at least one lateral face of the base material, and an angle between the surface and the at least one lateral face is less than 90 degrees.

### BACKGROUND OF THE INVENTION

1. Field of the Invention

The present invention relates to a radiation detection panel and a radiation imaging apparatus, and more particularly to a radiation detection panel and a radiation imaging apparatus in which a narrow bezel for use in mammography is realized.

2. Description of the Related Art

Research and development are actively under way for digital radiation detection apparatuses including an X-ray phosphor layer and a two-dimensional photodetector because of their good image characteristics and their ability to share data by loading obtained data, which is digital data, into networked computer systems.

Among such digital radiation detection apparatuses, a radiation detection apparatus in which a phosphor layer for converting radiation to light detectable by photosensors is formed on a photodetector including a photoelectric conversion element portion in which a plurality of electric elements such as the photosensors and TFTs (thin film transistors) are two-dimensionally disposed is known to provide high sensitivity and high resolution.

Japanese Patent Laid-Open No. 2002-267758 discloses an X-ray imaging apparatus including a photoelectric conversion substrate in which a plurality of sets, each including a photoelectric conversion element and a thin film transistor, are arrayed substantially equidistantly in a two dimensional configuration, a drive processing circuit substrate for driving the photoelectric conversion substrate, a signal processing circuit substrate for processing output from the photoelectric conversion substrate, and a wavelength conversion member for converting X rays to visible light. The wavelength conversion member converts a distribution of X rays transmitted via a subject or an X-ray image to a visible light distribution or a visible light image. The photoelectric conversion substrate performs photoelectric conversion to convert the visible light image to a charge distribution or electric signals. Furthermore, the X-ray imaging apparatus includes a support member on which the photoelectric conversion substrate is placed, and either one of the drive processing circuit substrate and the signal processing circuit substrate is disposed so as to be inclined at approximately 45 degrees with respect to the detection surface of the photoelectric conversion substrate toward the opposite side of the photoelectric conversion substrate across the support member. The other one of the drive processing circuit substrate and the signal processing circuit substrate is disposed so as to be substantially parallel to the detection surface of the photoelectric conversion substrate on the opposite side of the photoelectric conversion substrate across the support member.

Japanese Patent Laid-Open No. 2006-052983 discloses a radiation detection apparatus in which a polyimide film prepared by vapor deposition polymerization is used as a phosphor protective layer formed on top of a phosphor layer made of CsI:Tl of columnar crystal structure, a polyurea film prepared by vapor deposition polymerization is used as a reflective layer protective layer formed on a reflective layer, and the two films are formed such that their end faces are thinner toward the outside. The layers are formed in the manner described above in expectation of obtaining a structure that is resistant to external stress at the end faces. The two films are also formed on the side of the sensor panel opposite to the side on which the phosphor layer is formed, and the end faces are also formed thinner toward the outside. By forming the layers as described above, they function as a cushion against external mechanical stress applied to the back surface of the sensor panel, and it is therefore possible to obtain a sensor panel structure with high impact resistance.

However, the techniques of Japanese Patent Laid-Open Nos. 2002-267758 and 2006-052983 have not achieved a narrow bezel for FPD cassettes for use in mammography. Narrow bezel used herein refers to a region whose distance from one side of a cassette is small (for example, 2 mm or less) and to which imaging is possible.

### SUMMARY OF THE INVENTION

In view of the problems described above, the present invention provides a radiation detection panel in which a narrow bezel is realized.

According to one aspect of the present invention, there is provided a radiation detection panel including a photoelectric conversion element that detects fluorescence by a phosphor layer, the radiation detection panel comprising: a base material for supporting the phosphor layer, including the photoelectric conversion element; and a protective film for covering the phosphor layer, wherein the phosphor layer is formed on a surface and at least one lateral face of the base material, and an angle between the surface and the at least one lateral face is less than 90 degrees.

Further features of the present invention will be apparent from the following description of exemplary embodiments with reference to the attached drawings.

### BRIEF DESCRIPTION OF THE DRAWINGS

FIG. 1A is a schematic plan view of a radiation detection apparatus according to a first embodiment of the present invention.

FIG. 1B is a schematic cross-sectional view of the radiation detection apparatus according to the first embodiment.

FIGS. 2A and 2B are diagrams illustrating a process for producing a radiation detection apparatus.

FIG. 3 is a diagram illustrating the process for producing a radiation detection apparatus.

FIG. 4 is a diagram illustrating the process for producing a radiation detection apparatus.

FIG. 5 is a flowchart illustrating the procedure for producing a radiation detection apparatus.

FIG. 6 is a schematic cross-sectional view of a radiation detection apparatus according to a second embodiment of the present invention.

FIG. 7 is a schematic cross-sectional view of a radiation detection apparatus according to a third embodiment of the present invention.

FIG. 8 is a schematic cross-sectional view of the radiation detection apparatus according to the first embodiment, which is not the chest wall side.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

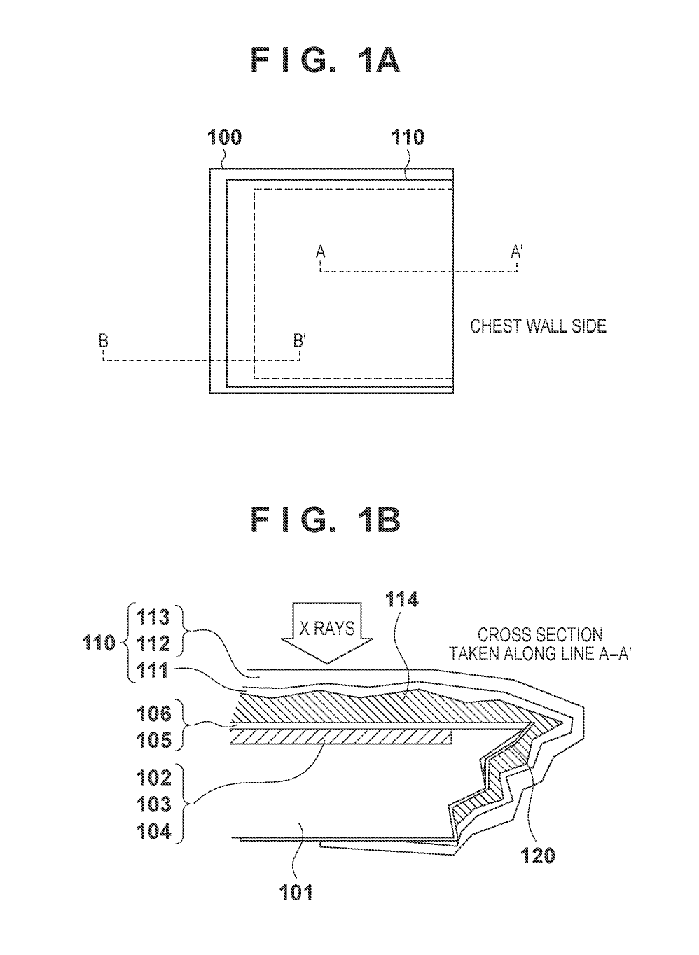

A radiation detection apparatus (also referred to as a radiation detection panel or a two-dimensional photodetector) according to a first embodiment of the present invention will be described with reference to FIGS. 1A and 1B. Radiation includes, in addition to X rays, α rays, β rays, γ rays and the like. FIG. 1A is a schematic plan view of the radiation detection apparatus, and FIG. 1B is a cross-sectional view taken along the line A-A′ in FIG. 1A.

As shown in FIG. 1B, a sensor panel 100 as a radiation detection apparatus includes a glass substrate 101, a photoelectric conversion element portion 102, a wiring portion 103, a contact lead 104, a protective layer 105, a phosphor underlayer 106, and an antireflection layer 120.

The glass substrate 101 is a base material that constitutes the base portion of the radiation detection apparatus. The photoelectric conversion element portion 102 is composed of, for example, photosensors and TFTs that are made of amorphous silicon. The wiring portion 103 and the contact lead 104 are included in the photoelectric conversion element portion 102.

The protective layer 105 is made of, for example, silicon nitride. Other than SiN, TiO₂, LiF, Al₂O₃ and MgO, it is possible to use polyphenylene sulfide resin, fluorocarbon resin, polyether ether ketone resin, liquid crystal polymer, polyether nitrile resin, polysulfone resin, polyether sulfone resin, polyarylate resin, polyamide imide resin, polyether imide resin, polyimide resin, epoxy resin, silicone resin, and the like. In particular, since light that has been converted by the phosphor during emission of radiation passes through the protective layer 105, it is desirable to use materials that have high transmission at the wavelengths of light emitted by the phosphor.

The phosphor underlayer 106 is an underlayer made of a resin film or the like, and also functions as a rigid protective layer for the photoelectric conversion element portion 102. The phosphor underlayer 106 may be made of any material as long as it is capable of withstanding a thermal process (200° C. or higher) in a phosphor layer forming step due to columnar phosphor. Examples include polyamide imide resin, polyether imide resin, polyimide resin, epoxy resin, silicone resin, and the like.

A phosphor protective member 110 includes a phosphor protective layer 111, a reflective layer 112, and a protective base material 113. The phosphor protective member 110 has moisture preventive and protective functions for the photoelectric conversion element portion 102 formed on the sensor panel 100 and a later-described phosphor layer 114, and may be configured as at least one layer made of material having low water permeability.

The phosphor protective layer 111 is made of organic resin or the like, and serves to provide adhesion between the phosphor protective member 110 and the phosphor layer 114. The phosphor protective layer 111 is provided for the purpose of adhesively fixing the phosphor protective member 110, which covers the photoelectric conversion element portion 102 of the sensor panel 100, to the phosphor layer 114, as well as providing moisture preventive and protective functions for the phosphor layer 114 and the photoelectric conversion element portion 102. The phosphor protective layer 111 is made of resin that provides adhesion to other organic or inorganic material when in a heated molten state and that becomes solid at room temperature and does not provide adhesion. Any material can be used as long as the above requirements are met. Particularly, it is preferable to use resin having low water permeability. It is possible to use a heat curable adhesive that cures when heated, for example, addition reaction silicone, heat curable acrylic or epoxy resin, or hot melt resin (thermoplastic resin) which is plasticized when heated and becomes capable of fusing such as polyolefin. By making the phosphor protective layer 111 made of a thermoplastic resin layer described above thicker than the phosphor layer 114 (not shown), mechanical impact on the periphery portion of the glass substrate 101 can be moderated.

Preferable materials for the reflective layer 112 include metals having high reflectivity such as Al, Ag, Cr, Cu, Ni, Ti, Mg, Rh, Pt and Au. The protective base material 113 is a base material on which the reflective layer 112 is formed in advance, and can be an organic material such as PET. The reflective layer 112 and the protective base material 113 constitute a protective film.

The phosphor layer 114 is a layer made of columnar phosphor. For the phosphor layer 114, an alkali halide activator is preferably used. Other than CsI:Tl, CsI:Na, NaI:Tl, LiI:Eu, KI:Tl and the like can be used. The phosphor layer 114 is supported by the glass substrate 101 serving as the base.

An antireflection layer 120 prevents fluorescence from the top face (surface) from being reflected at the lateral faces and the bottom face (back surface) of the glass substrate 101, as well as preventing fluorescence from the phosphor layer 114 formed on the lateral faces of the glass substrate 101 from entering the photoelectric conversion element portion 102 through the lateral faces.

In the present embodiment, an example will be described in which, as a sensor panel 100 that is a two-dimensional photodetector, a photoelectric conversion element portion 102 composed of photosensors and TFTs that are made of amorphous silicon is formed on a glass substrate 101. However, the present embodiment is not limited thereto, and a similar radiation detection apparatus can be configured by disposing an underlayer and a phosphor layer on a semiconductor single crystalline substrate on which two-dimensionally disposed image sensors such as CCD or CMOS sensors are formed. This applies to other embodiments as well.

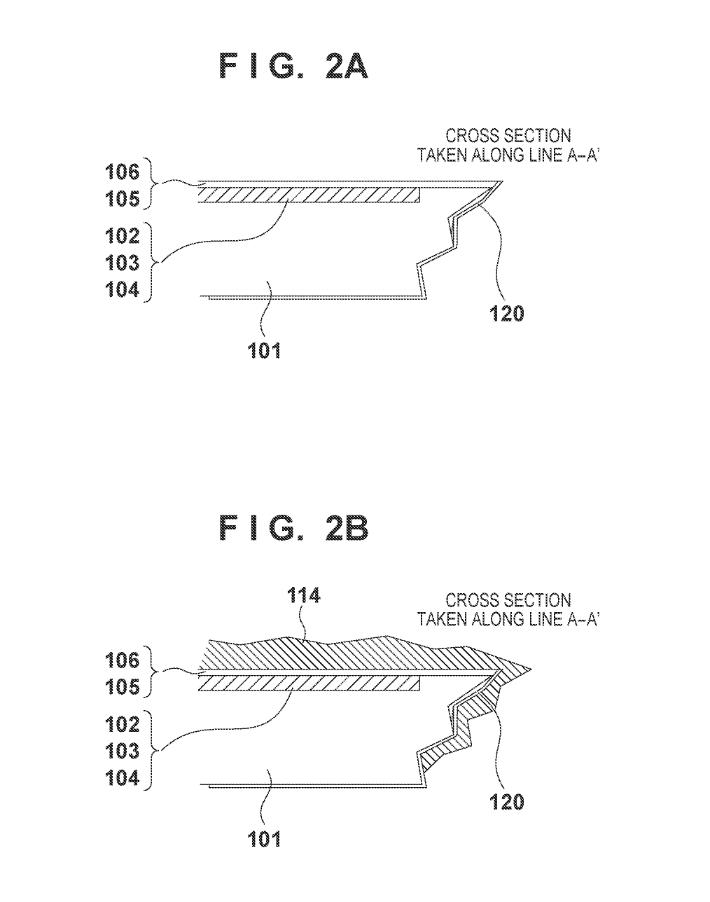

A method for producing the radiation detection apparatus discussed with reference to FIGS. 1A and 1B will be described. FIGS. 2A, 2B, 3 and 4 show a process for producing the radiation detection apparatus. FIGS. 2A to 4 show schematic cross-sectional views taken along the line A-A′ of FIG. 1A.

FIG. 5 is a flowchart illustrating a procedure for producing a radiation detection apparatus according to the present invention. First, in step S501, as shown in FIG. 2A, a photoelectric conversion element portion (photo-detection elements (pixels)) 102 including photosensors and TFTs and a wiring portion 103 are formed on a thin semiconductor film of amorphous silicon on a glass substrate 101.

In step S502, cutting is performed on at least one lateral face of the glass substrate 101 (for example, the chest wall-side lateral face that is brought into contact with the chest of a patient). Cutting is performed such that an inwardly inclined slope is formed, specifically, the angle between the top face (surface) of the glass substrate 101 and the lateral face is less than 90 degrees.

The cutting method can be diamond cutting, laser cutting or the like. In either case, cutting is performed such that the lateral face of the glass substrate 101 is inwardly inclined. The lateral face of the glass substrate 101 is cut so as to be rougher than the top face. Rough surfaces can be easily formed by diamond cutting. By making the surface rough, it is possible to prevent, when a phosphor layer 114 is formed, a phosphor from flowing over the lateral face of the glass substrate 101 and adhering to the bottom face of the same. Lateral faces other than the chest wall side (line A-A′) of FIG. 1A do not need to be cut to a slope. This is because the narrow bezel does not need to be formed around the entire radiation detection apparatus. However, a lateral face(s) may also be cut to a slope if the narrow bezel needs to be formed, in addition to the chest wall-side lateral face (line A-A′).

In step S503, a protective layer 105 made of SiN_{X} and a phosphor underlayer 106 obtained by curing polyimide resin are formed on the photoelectric conversion element portion 102 and the wiring portion 103.

In step S504, an antireflection layer 120 is formed on the lateral and bottom faces of the glass substrate 101. Forming the antireflection layer 120 produces the effect of suppressing reduction of contrast of radiation images caused by fluorescence from the lateral faces entering the glass substrate 101.

Next, in step S505, as shown in FIG. 2B, a phosphor layer 114 made of phosphor (for example, CsI:Tl, thallium-doped cesium iodide) comprising columnar crystals of alkali halide is formed by a phosphor formation vapor deposition apparatus (not shown). The phosphor layer 114 is formed on the phosphor underlayer 106 so as to have a thickness of approximately 0.5 mm and cover the top face of the two-dimensionally disposed photoelectric conversion element portion 102. The phosphor layer 114 is formed on the surface side and the lateral face side of the glass substrate 101.

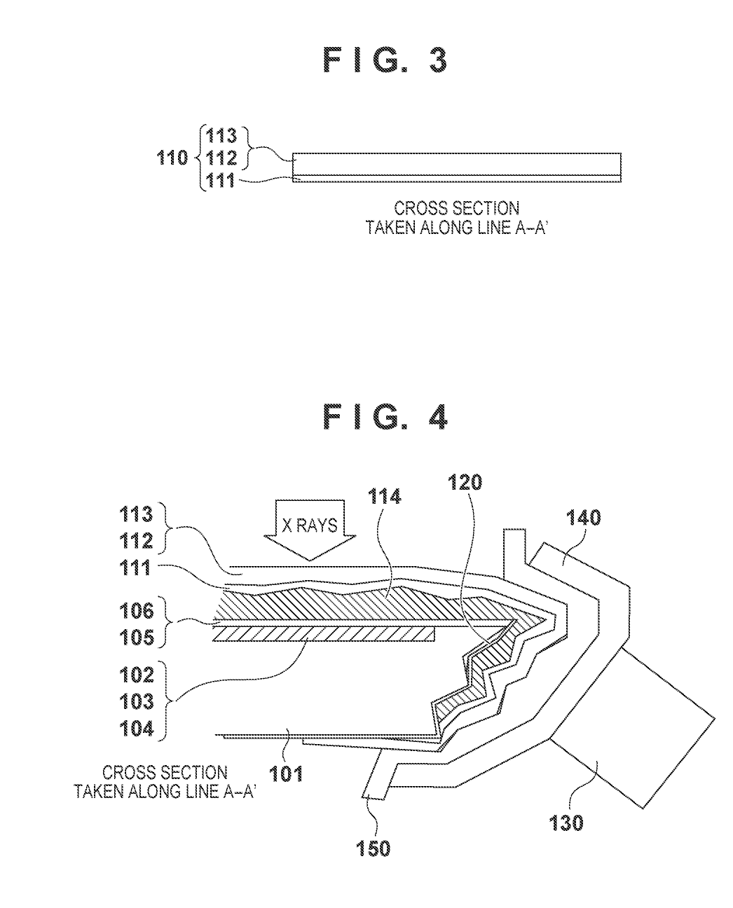

Then, in step S506, as shown in FIG. 3, with the use of a heat roller (not shown), a phosphor protective layer 111 made of hot-melt organic resin such as polyolefin resin is adhesively transferred onto one side of a phosphor protective member 110 that is in the form of a film and includes a 25 μm thick protective base material 113 made of PET and an Al film serving as a reflective layer 112 formed on the protective base material 113, the side being the side on which the reflective layer 112 is formed.

Next, in step S507, the phosphor protective member 110 including the phosphor protective layer 111 is bonded to one side of the sensor panel 100 including the phosphor layer 114 shown in FIG. 2B, the side being the side on which the phosphor layer 114 is formed, by pressing with a pressure roller (not shown). At this time, it is performed at room temperature without heating the pressure roller and a stage (not shown) for holding the sensor panel 100. The phosphor protective layer 111 made of hot melt resin does not melt in this step and thus is not bonded because thermoplastic resin having a melting point of approximately 100° C. is used in the present embodiment.

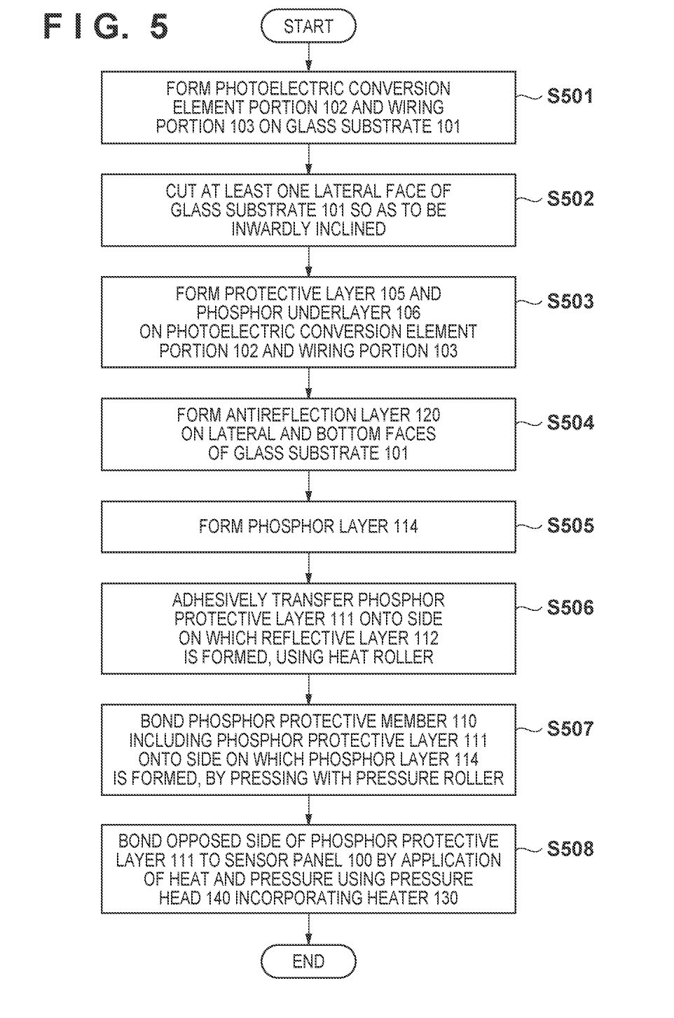

Next, in step S508, as shown in FIG. 4, with the use of a linear pressure head 140 incorporating a heater 130, the opposed side of the phosphor protective layer 111 is heated, pressed and bonded to the sensor panel 100. In the present embodiment, bonding is performed by applying heat and pressure from above the phosphor protective member 110 using the pressure head 140 that is long enough to press one of the sides of the phosphor protective member 110 at a time, and is sequentially performed from one side to the other. A buffer material 150 shown in FIG. 4 is for uniformalizing pressure force between the pressure head 140 and the surface of the sensor panel 100, and for example, 0.3 mm thick silicone rubber is used. In the present embodiment, the heater head temperature is controlled such that the temperature of the phosphor protective layer 111 reaches 120° C., and heat adhesion is performed for 10 seconds. In this way, a radiation detection apparatus of the present embodiment as shown in FIG. 1 is produced.

The radiation detection panel of the present embodiment does not necessarily include all the layers (films) described above, and may include any combination thereof. Also, the protective base material 113 and the reflective layer 112 that constitute a protective film for covering the phosphor layer 114 may be configured to cover the surface side and the lateral face side of the glass substrate 101, or may be configured to further cover the back surface side.

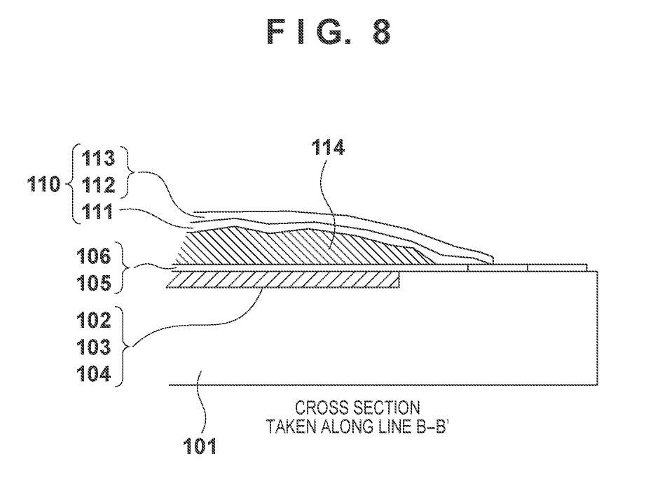

FIG. 8 shows a cross section taken along the line B-B′ shown in FIG. 1A. In the FPD cassette for use in mammography, the processing of the present embodiment is not performed on the three lateral faces other than the chest wall-side lateral face, and thus they have a cross-sectional configuration illustrated in FIG. 8. The present invention is applicable to at least one lateral face, and may be applied to the three lateral faces other than the chest wall-side lateral face.

As described above, phosphor can be used as a buffer material against destruction of the film (phosphor protective film) disposed in the periphery. Also, the area in which photoelectric conversion elements are disposed can be extended to the edge of the glass substrate (for example, 2 mm or less from the edge), and it is therefore possible to realize a narrow bezel at a low cost. This is applicable to both direct deposition and indirect deposition. With the use of a radiation imaging apparatus including the radiation detection apparatus of the present invention, radiation images with a narrow bezel can be obtained.

### Second Embodiment

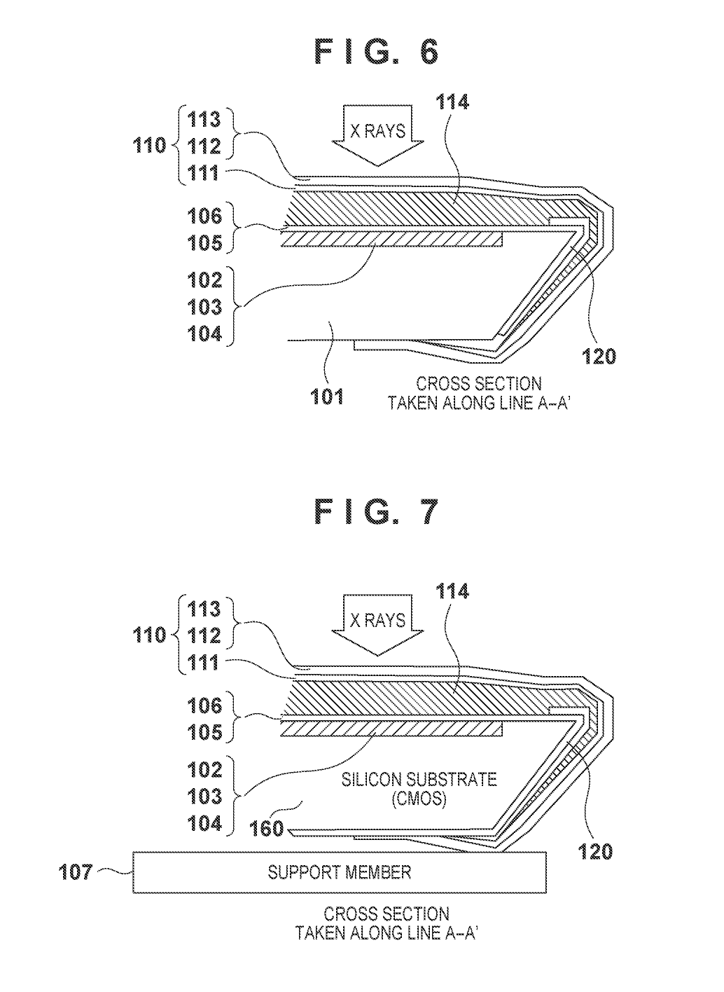

As shown in FIG. 6, this embodiment is different from the first embodiment in the method for forming an antireflection layer 120 performed in step S504. Specifically, the difference is that an antireflection layer 120 is formed not only on the lateral face and the bottom face of the glass substrate 101 but also on the top face of the glass substrate 101. An antireflection layer 120 with a width of approximately 0.5 mm to 1 mm is formed in the periphery portion of the top face of the glass substrate 101. In other words, in a specific region from the border of the lateral face on the surface of the glass substrate 101 as well, the antireflection layer 120 is formed between the phosphor layer 114 and the glass substrate 101.

By forming the antireflection layer 120 in the periphery portion of the top face of the glass substrate 101, the thickness of the phosphor layer 114 can be controlled. By forming the antireflection layer 120 on the top face, it is possible to suppress reduction of the thickness of the phosphor layer 114 in the periphery portion of the top face of the glass substrate 101.

### Third Embodiment

As shown in FIG. 7, this embodiment is different from the first embodiment in the material of the photoelectric conversion element portion 102. The first embodiment described an example in which a photoelectric conversion element portion 102 including photosensors and TFTs that are made of amorphous silicon is formed on a glass substrate 101, but in the present embodiment, the photoelectric conversion element portion 102 is made of crystal silicon, rather than amorphous silicon.

An example of the photoelectric conversion element portion 102 of the present embodiment is a CMOS sensor. The CMOS sensor needs to be insulated before attached to a support member 107 because the CMOS sensor has conductivity. In the third embodiment, a silicone substrate 160 is used as a base material instead of the glass substrate 101, an insulating protective layer 105 is formed on the top face of the silicone substrate 160 as an insulating layer, and a phosphor underlayer 106 is formed on the top face of the insulating protective layer 105. Besides the above, the production method is the same as that of the first embodiment.

As described above, according to the embodiments given above, it is possible to provide radiation detection panels in which a narrow bezel is realized.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-132708 filed on Jun. 14, 2011, which is hereby incorporated by reference herein in its entirety.

What is claimed is:

1. A radiation detection panel including a photoelectric conversion element that detects fluorescence by a phosphor layer, the radiation detection panel comprising:
a base material for supporting the phosphor layer, including the photoelectric conversion element; and
a protective film for covering the phosphor layer,
wherein the phosphor layer is formed on a surface and at least one lateral face of the base material, and an angle between the surface and the at least one lateral face is less than 90 degrees.

2. The radiation detection panel according to claim 1,
wherein the protective film covers the phosphor layer and is also formed on a back surface of the base material.

3. The radiation detection panel according to claim 1,
wherein the lateral face is formed to be rougher than the surface.

4. The radiation detection panel according to claim 1,
wherein, in the lateral face, an antireflection layer is formed between the phosphor layer and the base material.

5. The radiation detection panel according to claim 4,
wherein the antireflection layer is formed between the phosphor layer and the base material in a specific region from a border of the lateral face on the surface of the base material.

6. The radiation detection panel according to claim 1,
wherein the base material is formed of silicon, and an insulating layer is formed on the surface of the base material.

7. The radiation detection panel according to claim 1,
wherein a thermoplastic resin layer is formed between the phosphor layer and the protective film, and in the lateral face of the base material, the thermoplastic resin layer is thicker than the phosphor layer.

8. A radiation imaging apparatus comprising the radiation detection panel according to claim 1.
